(19) United States
(12) Patent Application Publication
(10) Pub. No.: US 2026/0246797 A1
(43) Pub. Date: Aug. 20, 2026

(54) INFORMATION PROCESSING METHOD

(71) Applicant: NTT, Inc., Tokyo (JP)

(72) Inventors: Kazuma SHINOMIYA, Musashino-shi, Tokyo (JP); Kazunori KAMIYA, Musashino-shi, Tokyo (JP)

(73) Assignee: NTT, Inc., Tokyo (JP)

(21) Appl. No.: 19/162,061

(22) PCT Filed: Mar. 15, 2023
(86) PCT No.: PCT/JP2023/010194

§ 371 Date: Sep. 4, 2025

(51) Int. Cl. H04L 9/40

(52) U.S. Cl. CPC H04L 63/1425

(57) ABSTRACT

An information processing method executed by an information processing device, includes first extracting a feature amount of each host of an IP address on a communication network by analyzing data observed in the communication network, second extracting a malicious IP address and a feature amount of a host of the malicious IP address by analyzing a search result obtained when searching for the malicious IP address from maliciousness-suspected IP addresses on the communication network, clustering IP address groups on the communication network into a plurality of clusters by using the feature amount extracted in the first extracting and the feature amount extracted in the second extracting, and calculating a distance from the malicious IP address by using the feature amount extracted in the first extracting and the feature amount extracted in the second extracting, for each IP address belonging to a cluster to which the malicious IP address belongs.

### TECHNICAL FIELD

The present invention relates to an information processing method for efficiently finding a malicious IP address from a vast IP address space.

### BACKGROUND ART

In the related art, a technique for searching for an IP address on an IPV4 space to find a malicious IP address is known.

For example, there is known a technique of performing searching only for IP addresses advertised by a border gateway protocol (BGP) (refer to, for example, Non Patent Literature 1 and Non Patent Literature 2).

In addition, for example, in searching for a malicious website, there is known a technique of predicting a malicious score for each URL by machine learning based on WHOIS information, an associated FQDN, a numerical value of each octet of an IP address, and the like and rearranging the URLs in order of the malicious score (refer to, for example, Non Patent Literature 3).

### CITATION LIST

### Non Patent Literature

Non Patent Literature 1: Antonio Nappa, et al., “CyberProbe: Towards Internet-Scale Active Detection of Malicious Servers”, NDSS, 2014.
Non Patent Literature 2: Zhaoyan Xu, et al., “AUTOPROBE: Towards Automatic Active Malicious Server Probing Using Dynamic Binary Analysis”, ACM CCS, 2014
Non Patent Literature 3: Daiki Chiba, Tatsuya Mori, Shigeki Goto, “Deciding priority crawling in searching for malicious websites”, CSS, 2012.

### SUMMARY OF INVENTION

### Technical Problem

However, the techniques in the related art have a problem that a malicious IP address cannot be efficiently found from a vast IP address space.

For example, in the techniques described in Non Patent Literature 1 and Non Patent Literature 2, there are approximately 2.6 billion candidates after narrowing down from approximately 4.3 billion IP addresses on an IPV4 space, and the narrowing down is not sufficient.

In addition, for example, in many cases, a C&C server or a malicious file distribution server in a botnet does not have a domain name, or WHOIS or FQDN cannot be acquired. As a result, the technique of Non Patent Literature 3 cannot be applied in some cases. Further, the number of IP addresses is enormous (for example, approximately 4.3 billion), and as a result, ordering by machine learning has a very high calculation cost.

Therefore, an object of the present invention is to solve the above-described problems and to efficiently find a malicious IP address from a vast IP address space.

### Solution to Problem

In order to solve the above problems, according to the present invention, an information processing method executed by an information processing device, includes: a first step of extracting a feature amount of each host of an IP address on a communication network by analyzing data observed in the communication network; a second step of extracting a malicious IP address and a feature amount of a host of the malicious IP address by analyzing a search result obtained when searching for the malicious IP address from maliciousness-suspected IP addresses on the communication network; a step of clustering IP address groups on the communication network into a plurality of clusters by using the feature amount extracted in the first step and the feature amount extracted in the second step; a step of calculating a distance from the malicious IP address by using the feature amount extracted in the first step and the feature amount extracted in the second step, for each IP address belonging to a cluster to which the malicious IP address belongs among the plurality of clusters; and a step of outputting a list of the IP addresses ranked in ascending order of the distance from the malicious IP address, for the IP address groups in the cluster.

### Advantageous Effects of Invention

According to the present invention, it is possible to efficiently find a malicious IP address from a vast IP address space.

### BRIEF DESCRIPTION OF DRAWINGS

FIG. 1 is a diagram for explaining an outline of an information processing device.

FIG. 2 is a diagram illustrating a configuration example of the information processing device.

FIG. 3 is a diagram for explaining an outline of a first data analysis unit in FIG. 2.

FIG. 4 is a diagram for explaining an outline of a second data analysis unit in FIG. 2.

FIG. 5 is a diagram for explaining an outline of a data integration unit in FIG. 2.

FIG. 6 is a flowchart illustrating an example of a processing procedure executed by the information processing device.

FIG. 7 is a diagram illustrating a computer that executes an information processing program.

### DESCRIPTION OF EMBODIMENTS

Hereinafter, a mode for carrying out the present invention (embodiment) will be described with reference to the drawings. The present invention is not limited to the present embodiment.

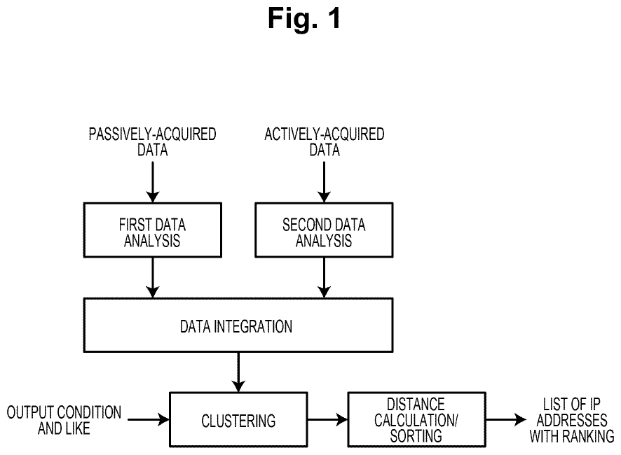

First, a configuration of an information processing device that executes an information processing method according to the present embodiment will be described with reference to FIG. 1. The information processing device generates and outputs a list of maliciousness-suspected IP addresses (for example, a list of IP addresses with ranking) using a feature amount of an IP address group in an IP address space.

The information processing device analyzes data (passively-acquired data) passively observed at an observation point on a communication network (first data analysis). The passively-acquired data is, for example, network flow data, BGP data, WHOIS data, passive DNS data, or the like. The information processing device extracts a feature amount from an analysis result of the passively-acquired data.

In addition, the information processing device analyzes data (actively-acquired data) obtained by searching for a communication network (second data analysis). The actively-acquired data is, for example, data acquired by actively accessing an arbitrary host, such as an output result of a search program or an Internet scan result. The information processing device extracts a feature amount of a malicious host and an IP address (malicious IP address) of a malicious host from the analysis result of the actively-acquired data.

The information processing device stores information obtained by the first data analysis and information obtained by the second data analysis for each IP address (data integration).

Thereafter, the information processing device clusters an IP address group into a plurality of clusters by using the feature amount stored by the data integration (clustering).

Next, the information processing device calculates a distance from the malicious IP address to an IP address group (a group of IP addresses that may be malicious) belonging to a cluster to which the malicious IP address belongs among the plurality of clusters. In the calculation of the distance, a feature amount of each IP address of the IP address group is used. The information processing device sorts the IP address groups in ascending order of distance from the malicious IP address (distance calculation/sorting).

Then, the information processing device outputs a list of the sorted IP address groups (for example, a list of IP addresses with ranking). At this time, the information processing device may output, for example, a list of IP addresses of which the number or the property satisfies an output condition set by a user.

By using the list, it is possible to perform searching in order from the IP address that is most likely to be malicious among the IP addresses in the vast IP address space, and thus, it is possible to efficiently find the malicious IP address.

### Configuration Example

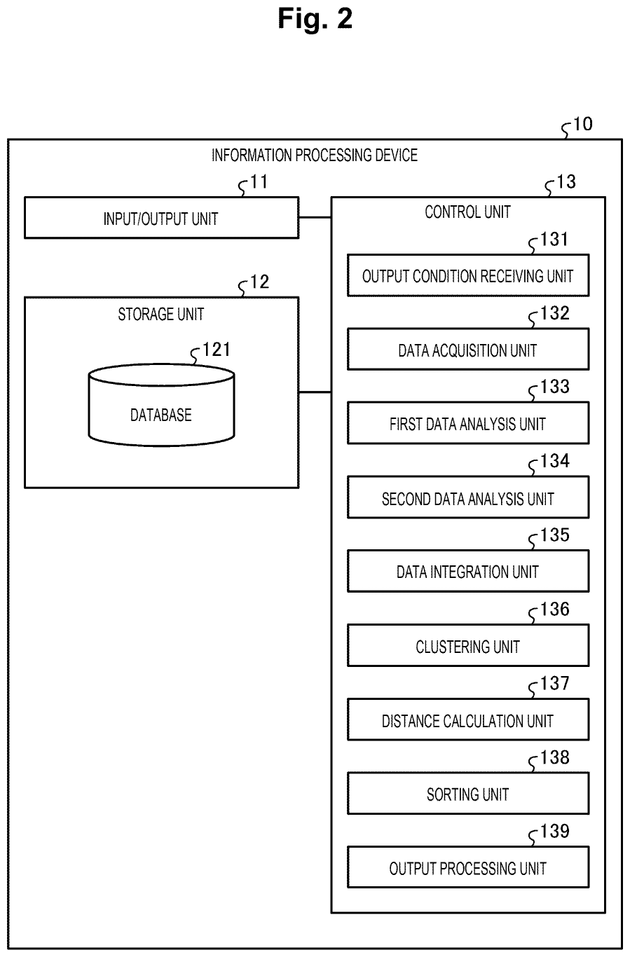

Next, a configuration example of an information processing device 10 will be described with reference to FIG. 2. The information processing device 10 includes, for example, an input/output unit 11, a storage unit 12, and a control unit 13.

The input/output unit 11 is an interface that controls input and output of various types of data. The storage unit 12 stores data, programs, and the like that are referred to when the control unit 13 executes various types of processing.

The storage unit 12 includes, for example, a database 121 that stores data output by the control unit 13. The database 121 stores, for example, data indicating a feature amount of each IP address that is output by the control unit 13. The storage unit 12 is realized by a semiconductor memory element such as a random access memory (RAM) or a flash memory, or a storage device such as a hard disk or an optical disc.

The control unit 13 controls the entire information processing device 10. The function of the control unit 13 is implemented by, for example, a central processing unit (CPU) executing a program stored in the storage unit 12.

The control unit 13 includes, for example, an output condition receiving unit 131, a data acquisition unit 132, a first data analysis unit 133, a second data analysis unit 134, a data integration unit 135, a clustering unit 136, a distance calculation unit 137, a sorting unit 138, and an output processing unit 139.

The output condition receiving unit 131 receives a condition (output condition) when the control unit 13 outputs the sorted IP address groups. The output condition is, for example, a condition as to how many top-ranked IP addresses included in a list are to be output from the sorted IP address groups, a condition as to what kind of properties of IP addresses are to be output, and the like.

The data acquisition unit 132 acquires the passively-acquired data and the actively-acquired data. The first data analysis unit 133 analyzes the passively-acquired data, and extracts a feature amount of each host of the IP addresses on the communication network.

For example, the first data analysis unit 133 extracts, as the feature amounts, various feature amounts based on a result obtained by analyzing network flow data of the IP address, an advertisement IP address of the IP address based on a result obtained by analyzing BGP data, an AS number and an allocation range of the IP address, an allocation organization of the IP address based on a result obtained by analyzing WHOIS data, and the like.

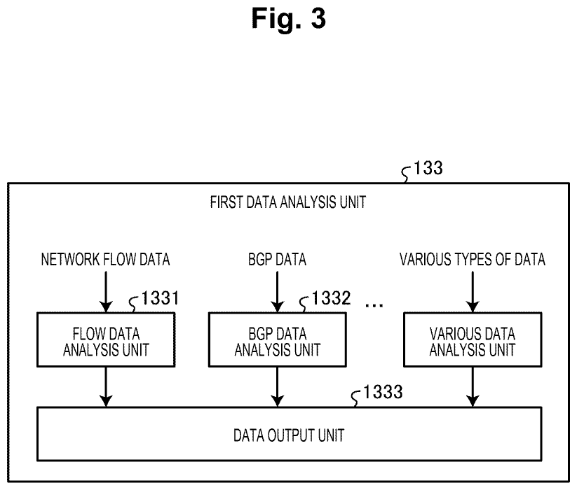

For example, as illustrated in FIG. 3, the first data analysis unit 133 includes analysis units that perform analysis for each type of the passively-acquired data. A flow data analysis unit 1331 analyzes network flow data. A BGP data analysis unit 1332 analyzes BGP data. Each analysis unit outputs an analysis result to a data output unit 1333.

The description returns to FIG. 2. The second data analysis unit 134 analyzes the passively-acquired data, and extracts a feature amount. For example, the second data analysis unit 134 extracts a malicious IP address and a feature amount of a host of the malicious IP address by analyzing a search result obtained when searching for the malicious IP address from the maliciousness-suspected IP addresses on the communication network.

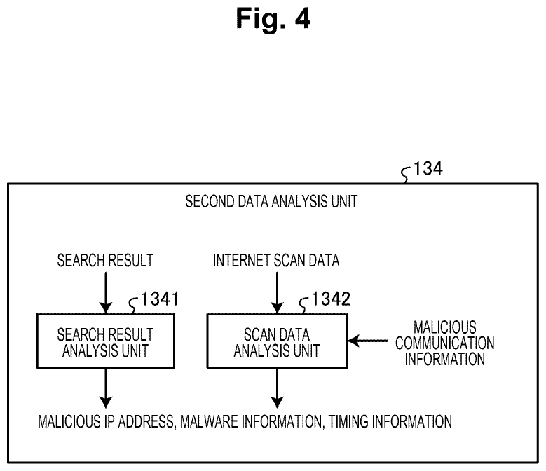

For example, as illustrated in FIG. 4, the second data analysis unit 134 includes a search result analysis unit 1341 and a scan data analysis unit 1342.

For example, the search result analysis unit 1341 analyzes at least one of a determination result obtained by a program for determining a malicious IP address, a determination date and time, or information related to malware.

Specifically, the search result analysis unit 1341 analyzes an output result of a search program that actually searches for a range of maliciousness-suspected IP addresses and outputs a truly-malicious IP address, and outputs a determination result, a maliciousness determination timing, malware information for identifying a type of malware to which a server transmits a command, and the like.

In addition, the scan data analysis unit 1342 can analyze Internet scan data output by an Internet scan program, and output a result obtained by estimating a malicious IP address and malware information.

Here, malicious IP address information is not assigned to the Internet scan data. On the other hand, malicious communication information included in the actively-acquired data includes information such as an IP address and a payload.

Therefore, the scan data analysis unit 1342 can obtain a malicious IP address by collating the Internet scan data with the actively-acquired data.

For example, in a case where the communication content of the Internet scan data matches with or is similar to the payload of the malicious communication information included in the actively-acquired data, the scan data analysis unit 1342 determines that a communication destination IP address and a port number are malicious.

The description returns to FIG. 2. The data integration unit 135 integrates the feature amounts (pieces of data) extracted by the first data analysis unit 133 and the second data analysis unit 134, and stores the integrated feature amounts in the database 121 for each IP address.

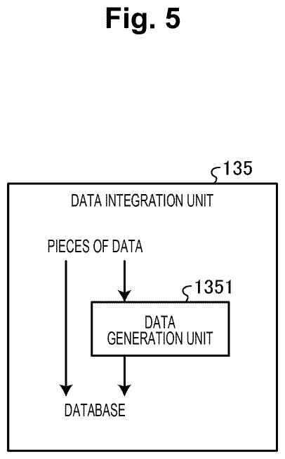

Note that, for example, as illustrated in FIG. 5, the data integration unit 135 may generate new information (feature amount) using each feature amount by the data generation unit 1351.

For example, the data generation unit 1351 generates an AS item to which each IP address belongs and an organization item to which each IP address belongs by using the malicious IP address information extracted by the second data analysis unit 134 (refer to FIG. 4) and the BGP information extracted by the first data analysis unit 133 (refer to FIG. 3).

In addition, for example, the data generation unit 1351 generates maliciousness of each IP address by the number of hops from the malicious IP address, by using the malicious IP address information extracted by the second data analysis unit 134 and the network flow information extracted by the first data analysis unit 133. Then, the data integration unit 135 stores the feature amount generated by the data generation unit 1351 in the database 121 in association with the IP address.

The description returns to FIG. 2. The clustering unit 136 clusters the IP address group that is output from the data integration unit 135 into a plurality of clusters by using the feature amount.

The distance calculation unit 137 calculates, a distance (a feature amount distance) to the malicious IP address by using the feature amount, for each IP address belonging to a cluster to which the IP address (the malicious IP address) of the malicious host belongs among the plurality of clusters generated by the clustering unit 136.

The sorting unit 138 sorts the IP address groups in the cluster to which the malicious IP address belongs in ascending order of the feature amount distance that is calculated by the distance calculation unit 137.

The output processing unit 139 outputs the IP address groups sorted by the sorting unit 138. For example, the output processing unit 139 outputs a list of the IP addresses ranked in ascending order of the feature amount distance from the malicious IP address, for the sorted IP address groups. At this time, the output processing unit 139 outputs, for example, a list of the IP addresses of which the number or the property satisfies the output condition that is input by the output condition receiving unit 131.

### Example of Processing Procedure

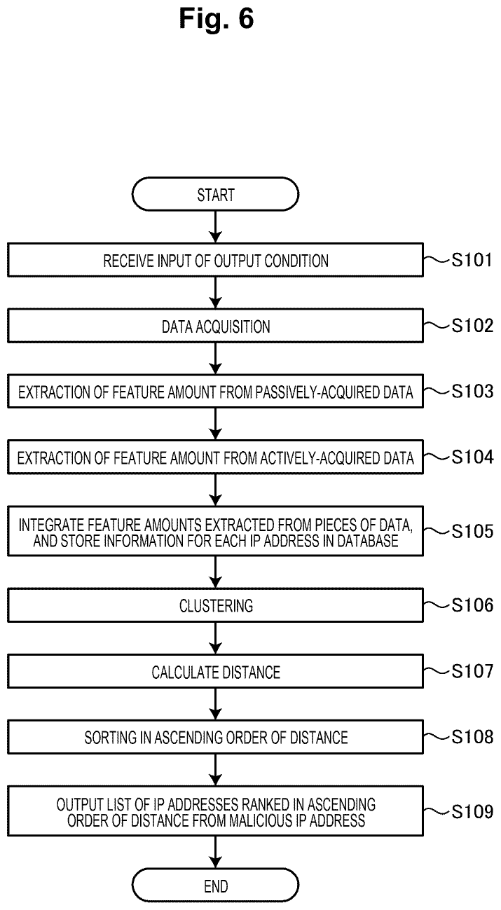

Next, an example of a processing procedure executed by the information processing device 10 will be described with reference to FIG. 6. First, the output condition receiving unit 131 of the information processing device 10 receives, from a user, an input of a condition (output condition) when the control unit 13 outputs a list of the IP addresses (a list of the maliciousness-suspected IP addresses) (S101).

Thereafter, the data acquisition unit 132 acquires passively-acquired data and actively-acquired data (S102: data acquisition). Next, the first data analysis unit 133 extracts a feature amount by analyzing the passively-acquired data (S103: extraction of a feature amount from the passively-acquired data). In addition, the second data analysis unit 134 extracts a feature amount by analyzing the actively-acquired data (S104: extraction of a feature amount from the actively-acquired data).

Next, the data integration unit 135 integrates the feature amounts extracted from the pieces of data, and stores information for each IP address in the database 121 (S105). Then, the clustering unit 136 clusters the IP address groups stored in the database into a plurality of clusters by using the feature amounts of the IP addresses (S106).

Thereafter, the distance calculation unit 137 calculates a distance from the malicious IP address by using the feature amount, for each IP address belonging to the cluster to which the malicious IP address belongs among the plurality of clusters generated in S106 (S107).

After S107, the sorting unit 138 sorts the IP address groups in the cluster to which the malicious IP address belongs in ascending order of the distance from the malicious IP address (S108). Thereafter, the output processing unit 139 outputs a list of the IP addresses ranked in ascending order of the distance from the malicious IP address, for the sorted IP address groups (S109).

### System Configuration and the Like

In addition, each component of each illustrated unit is functionally conceptual, and does not necessarily have to be physically configured as illustrated. That is, a specific form of distribution and integration of each device is not limited to the illustrated form, and all or a part of the devices can be functionally or physically distributed and integrated in an arbitrary unit according to various loads, usage conditions, and the like. Further, all or an arbitrary part of processing functions performed by the respective devices can be implemented by a CPU and a program executed by the CPU or can be implemented as hardware by wired logic.

In addition, in the processing described in the above embodiment, all or some of the pieces of the processing described as being automatically performed may be manually performed, or all or some of the pieces of the processing described as being manually performed may be automatically performed by a known method. In addition, the processing procedure, the control procedure, the specific name, and the information including various kinds of data and parameters illustrated in the document and the drawings can be arbitrarily changed unless otherwise specified.

### Program

The information processing device 10 can be implemented by installing a program (information processing program) as package software or online software in a desired computer. For example, by causing an information processing device to execute the above program, the information processing device can be caused to function as the information processing device 10. The information processing device herein includes a mobile communication terminal such as a smartphone, a mobile phone, and a personal handyphone system (PHS) and further includes a terminal such as a personal digital assistant (PDA).

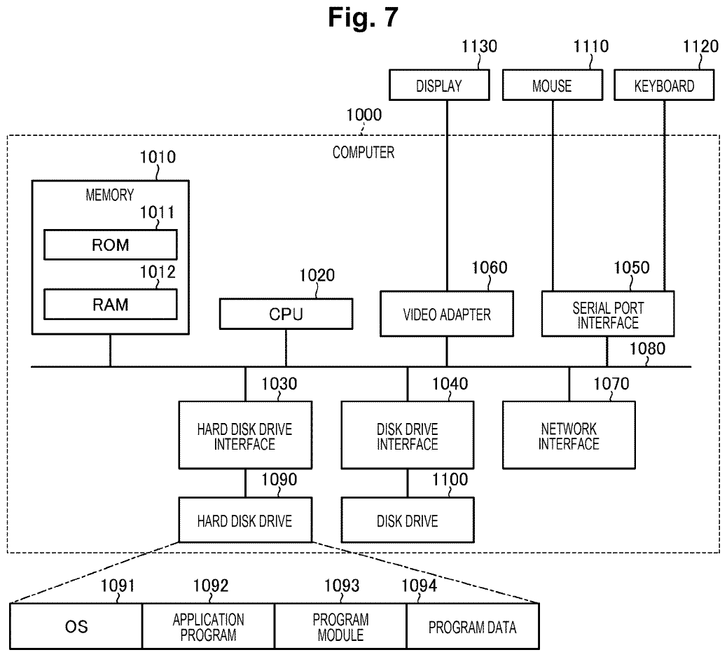

FIG. 7 is a diagram illustrating an example of a computer that executes an information processing program. A computer 1000 includes, for example, a memory 1010 and a CPU 1020. Further, the computer 1000 includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each piece of processing executed by the above information processing device 10 is implemented as a program module 1093 in which a code executable by a computer is described. The program module 1093 is stored in, for example, the hard disk drive 1090. For example, the program module 1093 for executing processing similar to the functional configuration in the information processing device 10 is stored in the hard disk drive 1090. Note that the hard disk drive 1090 may be replaced with a solid state drive (SSD).

Further, data used in the processing of the above embodiment is stored in, for example, the memory 1010 or the hard disk drive 1090 as the program data 1094. Then, the CPU 1020 reads the program module 1093 and the program data 1094 stored in the memory 1010 and the hard disk drive 1090 into the RAM 1012 as necessary, and executes the program module 1093 and the program data 1094.

Note that the program module 1093 and the program data 1094 are not limited to being stored in the hard disk drive 1090, and may be stored in, for example, a detachable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

### REFERENCE SIGNS LIST

10 Information processing device
11 Input/output unit
12 Storage unit
13 Control unit
131 Output condition receiving unit
132 Data acquisition unit
133 First data analysis unit
134 Second data analysis unit
135 Data integration unit
136 Clustering unit
137 Distance calculation unit
138 Sorting unit
139 Output processing unit

1. An information processing method executed by an information processing device, the information processing method comprising:
first extracting a feature amount of each host of an IP address on a communication network by analyzing data observed in the communication network;
second extracting a malicious IP address and a feature amount of a host of the malicious IP address by analyzing a search result obtained when searching for the malicious IP address from maliciousness-suspected IP addresses on the communication network;
clustering IP address groups on the communication network into a plurality of clusters by using the feature amount extracted in the first extracting and the feature amount extracted in the second extracting;
calculating a distance from the malicious IP address by using the feature amount extracted in the first extracting and the feature amount extracted in the second extracting, for each IP address belonging to a cluster to which the malicious IP address belongs among the plurality of clusters; and
outputting a list of the IP addresses ranked in ascending order of the distance from the malicious IP address, for the IP address groups in the cluster.

2. The information processing method according to claim 1,
wherein the data observed in the communication network is
at least one of network flow data, BGP data, WHOIS data, or passive DNS data, and
the feature amount of each host of the IP address on the communication network is
at least one of an analysis result of network flow data of the IP address, an advertisement IP address of the IP address that is obtained by analysis of BGP data, an AS number or an allocation range of the IP address, or an allocation organization of the IP address that is obtained by analysis of WHOIS data.

3. The information processing method according to claim 1,
wherein the feature amount of the host of the malicious IP address includes
at least one of a determination result as to whether or not the host is a malicious IP address, a date and time when the host is determined to be a malicious IP address, or information indicating as to which malware corresponds to the host that transmits a command.
